(19) United States
(12) Patent Application Publication
(10) Pub. No.: US 2013/0118853 A1
(43) Pub. Date: May 16, 2013

(54) Decoupling Pulley

(71) Applicants: François Champalou, Chaumont Sur Loire (FR); Didier Galteau, Cinq Mars La Pile (FR); Benoît Guillot, Larcay (FR); Hervé Varin, Joue Les Tours (FR)

(72) Inventors: François Champalou, Chaumont Sur Loire (FR); Didier Galteau, Cinq Mars La Pile (FR); Benoît Guillot, Larcay (FR); Hervé Varin, Joue Les Tours (FR)

(73) Assignee: HUTCHINSON, Paris (FR)

(21) Appl. No.: 13/147,062

(22) PCT Filed: Jul. 21, 2011
(86) PCT No.: PCT/IB11/53255

§ 371 Date: Oct. 20, 2011

(30) Foreign Application Priority Data
Aug. 2, 2010 (FR) 1056382

(51) Int. Cl. F16H 55/36

(52) U.S. Cl. CPC F16H 55/36
USPC 192/56.62

(57) ABSTRACT

The invention relates to a decoupling comprising two elements in rotation about a longitudinal axis, namely a rim and a hub, and also comprising a load support which ensures relative rotation between the rim and the hub, together with a torque transmission element positioned between the rim and hub, which comprises an elastic device deformable parallel to the longitudinal axis and comprising at least one elastic element, the pulley being characterized in that the torque transmission element comprises:—a first annular plate (1) connected in terms of rotation to one of the two elements, rim (4) or hub (3), and capable of moving axially with respect to thereto, having a first end face (11) in contact with a first end face (51) of the elastic device (5) and a second end face opposite to the first end face and comprising at least one first ramp path having at least one inclined zone (12, 14) forming a circular sector centred on the longitudinal axis and making a non-zero angle (α, α1, α2) with respect to a plane perpendicular to said longitudinal axis,—a second annular plate (2) connected in terms of rotation to the other of the two elements, hub (3) or rim (4), having an end face comprising at least a second ramp path having at least one inclined zone (22, 24) forming a circular sector centred on the longitudinal axis and making a non-zero angle (α, α1, α2) with respect to a plane perpendicular to said longitudinal axis,—a retaining cage (7) containing rolling elements (71) such as balls, positioned between the first (1) and the second (2) annular plate so that, depending on the relative rotational position of the rim (4) and of the hub, the deformable elastic device (5) is compressed axially by the combined action of at least one said rolling element (71) and of at least one said inclined zone (12, 14; 22, 24) of each of the first (1) and second (2) annular plates, the axial compression force thus generated being accompanied by a tangential force which is dependent on said angle and which transmits a torque between the first (1) and the second (2) annular plate and therefore between the rim (4) and the hub (3).

### FIELD OF THE INVENTION

The present invention relates to a decoupling pulley intended in particular for automobile applications as an accessory pulley (e.g. for an alternator), or as a crankshaft pulley.

### BACKGROUND OF THE INVENTION

Patent application U.S. 2009/194380 relates to an accessory pulley in which torque is transmitted between a rim and a hub by a combined friction and torsional force exerted by a stack of Belleville spring washers (or disk-shaped springs).

For this purpose (FIGS. 7 and 8 of application U.S. 2009/194380), a set comprising two cams spaced apart by a rolling bearing serves to compress the stack of Belleville spring washers to a greater or lesser extent. A first cam is engaged as a force-fit on the hub, while the other cam, which is free to rotate relative to the first cam, but which is constrained to rotate neither with the rim nor with the hub, is arranged facing the stack of Belleville spring washers.

In the rest position, the torque is at a minimum. When the pulley is driven, the cam paths turn relative to each other, thereby causing the stack of Belleville spring washers to be compressed and generating torsional and frictional torque via the Belleville spring washers, and as a result transmitting torque between the rim and the hub in order to produce filtering. The path followed by the torque between the rim and the hub is shown in FIG. 8 of that document, reproduced as FIG. 9 of the present application.

It can be seen that it passes via the stack of Belleville spring washers 400, thereby implying simultaneous torsional and frictional torque.

In addition, in order to operate, that system requires a large amount of initial prestress on the washers in order to enable them to drive the cams. The frictional torque and force are therefore high as soon as the system begins to rotate.

The fact of transmitting all of the torque by torsion and friction via the spring washers is not favorable in terms of length of life and reliability.

### OBJECT AND SUMMARY OF THE INVENTION

An object of the present invention is to provide a decoupling pulley that implements a resilient device that can be compressed axially, but that enables torsional torque to be transmitted without any need to subject the resilient device to friction forces or to torsional forces, i.e. the rotational torque is transmitted without passing via the resilient device.

The invention thus provides a decoupling pulley comprising two elements in rotation about a longitudinal axis, namely a rim and a hub, and also comprising a load support enabling relative rotation between the rim and the hub, together with a torque transmission element arranged between the rim and the hub, and including a resilient device that is deformable parallel to the longitudinal axis and including at least one resilient element, wherein the torque transmission element comprises:
a first annular clutchplate constrained to rotate with one of the two elements constituted by the rim and the hub, and axially movable relative thereto, having a first end face in contact with a first end face of the resilient device and a second end face, opposite from the first end face, and including at least a first ramp path having at least one inclined zone forming a circular sector centered on the longitudinal axis and forming a non-zero angle relative to a plane perpendicular to said longitudinal axis;
a second annular clutchplate constrained to rotate with the other one of the two elements comprising the hub and the rim, having an end face including at least one second ramp path having at least one inclined zone forming a circular sector centered on the longitudinal axis and making a non-zero angle relative to a plane perpendicular to said longitudinal axis; and
a holding cage including rolling elements such as balls, placed between the first and second annular clutchplates in such a manner that as a function of the relative angular position of the rim and the hub, the deformable resilient device is compressed axially by co-operation between at least one said rolling element and at least one said inclined zone of each of the first and second annular clutchplates, the axial compression force as generated in this way being accompanied by a tangential force that is a function of said angle and that transmits torque between the first and second annular clutchplates, and consequently between the rim and the hub.

In application U.S. 2009/194380, one of the cams is free to rotate relative both to the rim and to the hub. In contrast, in the invention, each of the first and second annular clutchplates carrying one or more ramp paths, is constrained to rotate with a respective different rotary element (rim or hub). Co-operation with one or more rolling elements that are free to revolve serves to resolve the forces into an axial force that compresses the resilient device axially and a tangential force that transmits torsional torque directly via the ramp paths without generating a torsional force on the resilient device. The torsional stiffness needed for filtering is thus obtained by direct conversion of the compression stiffness associated with the shape of the ramp, and forces are transmitted between the annular clutchplates and not through the stack of washers.

The above-mentioned angle may be constant.

The ramp path may include a non-inclined zone (α=0). In this zone, no torque is transmitted, thereby providing decoupling between the rim and the hub.

More particularly, the ramp path may include a non-inclined (α=0) central zone arranged between first and second inclined zones forming respective non-zero angles α1 and α2 relative to a plane perpendicular to said longitudinal axis. The angles α1 and α2 may optionally be equal, and they may optionally be constant. Their value(s) depend(s) on the stiffness that it is desired to obtain.

A said rolling element may be a ball.

The ramp path may have a radial dimension that decreases going away from a central region towards two end regions.

The pulley may include a plurality of balls housed in a ball cage and movable in rotation.

In a preferred embodiment, the ball cage includes balls that are not movable in rotation and that have the same diameter as the balls that are movable in rotation, or it includes shapes in relief having the same dimensions as the balls that are movable in rotation, to provide non-rolling contact with the ramp paths.

The resilient device may be a stack of spring washers such as Belleville washers, or it may comprise one or more coil springs.

Advantageously, the first annular clutchplate is constrained to rotate with the hub and the second annular clutchplate is constrained to rotate with the rim. Under such circumstances, it is preferable for the hub to include, opposite from the first end face of the deformable resilient device, an abutment element that is constrained to rotate together therewith that presents a bearing face for a second end face of the resilient device.

This abutment element may be an annular shoulder of the hub or it may be a bearing washer engaged around the hub, or indeed it may be an endplate of the hub.

In an advantageous embodiment, the above-mentioned angle increases from a minimum value in a starting region of the ramp in which the deformable resilient device is not axially compressed up to a maximum value in an end region of the ramp in which the deformable resilient device presents maximum axial compression.

The minimum value of the angle is preferably equal to 0°.

The variation of said angle may be defined by a polynomial curve (a spline) of second or third order passing via a first point corresponding to the minimum value of the angle α in the starting region of the curve, and via a second point corresponding to the maximum value in the region of the end of the curve, and optionally via an intermediate point corresponding to a nominal maximum torque for transmission between the rim and the hub, and to a predetermined angular stiffness.

By way of example, for an alternator, the intermediate point may correspond to a nominal maximum value for the transmitted driving torque being 12 newton meters (Nm) at an angular stiffness that lies in the range 0.3 newton meters per degree (Nm/°) to 0.9 Nm/°.

### BRIEF DESCRIPTION OF THE DRAWING

Other characteristics and advantages of the invention appear better on reading the following description with reference to the drawings, in which:

FIGS. 1a and 1b are respectively a longitudinal section view (seen in perspective) and an exploded view of an accessory pulley in an embodiment of the invention making use of Belleville spring washers;

FIGS. 2a to 2d, 3a to 3d, and 4a and 4b are diagrams of ramps in different functional positions for showing how forces are resolved, starting from the rest position shown in FIG. 2a;

FIG. 3e shows the torque transmitted between the clutchplates as a function of the angles α1 and α2;

FIG. 5 shows a variant of the embodiment of the invention shown in FIGS. 1a and 1b;

FIG. 6 shows a variant of the invention using a coil spring;

FIG. 7 shows a crankshaft pulley in an embodiment of the invention;

FIG. 8 shows a variant of the invention using two coil springs;

FIG. 9 shows how torque is transferred between the rim and the hub in patent application U.S. 2009/194380;

FIGS. 10a and 10b are graphs relating to a preferred embodiment in which the ramps present a profile with an angle α that increases continuously; and

FIGS. 11a and 11b are a perspective view and a longitudinal section view in an embodiment of the invention in which the movable balls are housed in a cage that also presents stationary balls or shapes in relief.

### MORE DETAILED DESCRIPTION

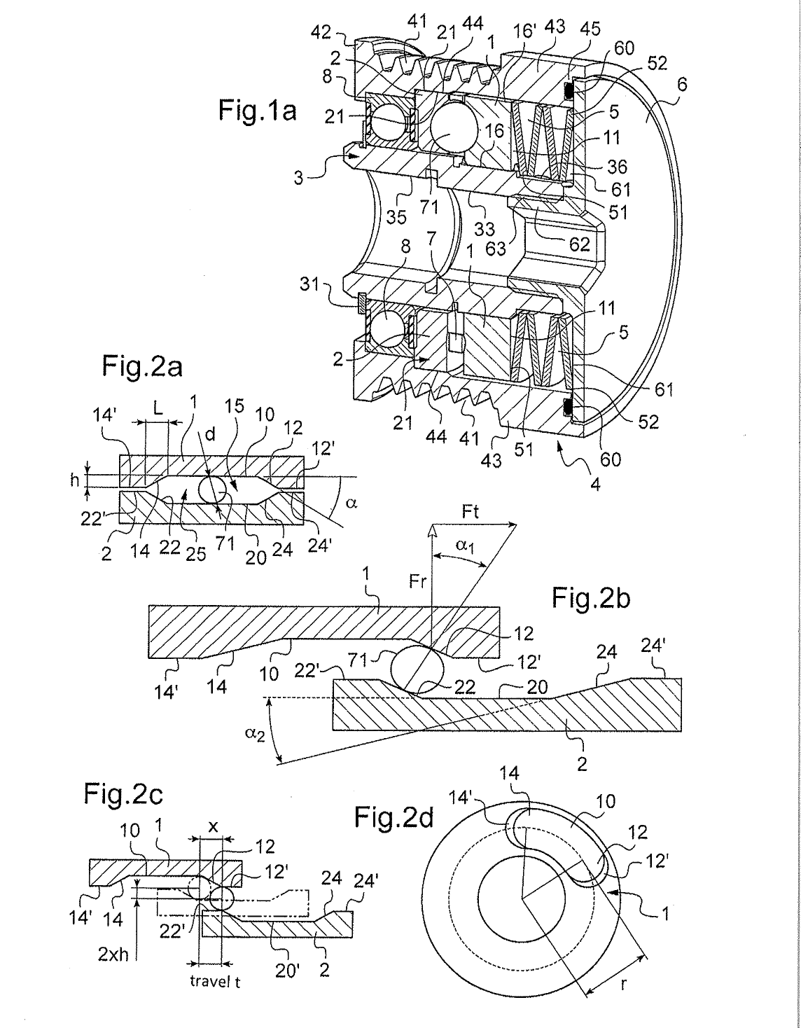

The accessory pulley shown in FIGS. 1a and 1b comprises a rim 4 with its outer outline 41 grooved to receive the teeth of a poly-V belt of type K. The rim 4 also presents a cylindrical region 43 that is axially spaced apart from the grooved outline 41.

The rim 4 has a ramped clutchplate 2 rigidly associated therewith, e.g. by its cylindrical outer outline 21 being engaged as a force-fit in an inner cylindrical region 44 of the rim 4, thereby ensuring that the clutchplate 2 cannot move axially relative to the rim 4. A load support (a plain or ball bearing) 8 is mounted between the rim 4 and the hub 3 to allow relative rotation between the rim 4 and the hub 3. The hub 3 provides a rotary connection with the shaft of an accessory, e.g. an alternator. The hub 3 has a fluted zone 31 formed thereon, and on which a movable ramped clutchplate 1 is free to move axially, but constrained to rotate with the hub 3 by fluting 16. Between the two ramped clutchplates 1 and 2, there is interposed a set of balls 71 held in position in a rigid cage 7. The movable clutchplate 1 bears via its end face 11 against the end face 51 of the resilient element (spring washers 5, or compression springs). The other end 52 of the resilient element 5 is kept in contact against the inside flank 61 of an endplate 6 constituting a bearing face. The endplate 6 is constrained rigidly to rotate with the hub 3 and is free to turn relative to the rim 4. To this end, it includes a cylindrical extension 62 of outer outline 63 that is screwed or otherwise engaged in the inner outline 33 of the hub 3. A sealing gasket 60 is received in a housing formed at the end 45 of the rim and is interposed between the endplate 6 and the rim 4. The sealing gasket 60 serves firstly to avoid leakage of the grease that may be needed for facilitating rolling of the rolling elements on the ramps, and secondly for preventing intrusions coming from the outside. The assembly is held in place by a locking clip 31.

In the rest state, axial prestress may be added to the resilient element 5. This prestress acts on the axially movable clutchplate 1, the ball cage 7, and the clutchplate 2. This serves to eliminate the construction clearances resulting from stacking the tolerances of all of the components.

In a variant, the clutchplate 2 may be secured to the hub 3 via its inner outline, while the axially movable clutchplate 1 is coupled to the rim 4 via a fluted outer outline that allows it to move axially. The end 52 of the resilient device 5 may come into abutment against a part that is secured to the rim 4 or against an annular collar thereof.

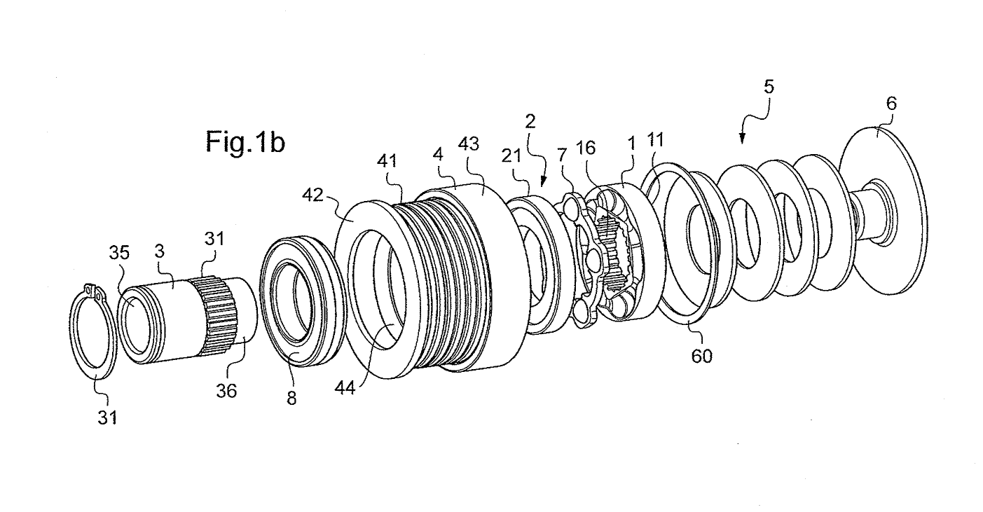

FIG. 2a shows the rest position in which the balls 71 of diameter d rest on a central region 20 having no slope (α=0) of the tracks 15 and 25 of the ramped clutchplates 1 and 2.

The track 15 presents a central region 10 without slope lying between two inclined regions 12 and 14 forming an angle α with the plane of the central region 10 that is perpendicular to the longitudinal axis of the pulley.

When torque is passed between the hub 3 and the rim (FIG. 2b), the ball 71 rises up the slopes, here 12 and 22, and the movement of the axially movable clutchplate 1 compresses the resilient device 5, thereby generating a force with an axial component Fr that is proportional to the compression of the resilient device 5, and a tangential component Ft that depends on Fr and on the value of the angle α, which angle is the same for both clutchplates. The coefficient of proportionality corresponds to the stiffness Kax of the resilient device 5. Furthermore, it is the tangential component that enables torque to pass directly between the clutchplates 1 and 2.

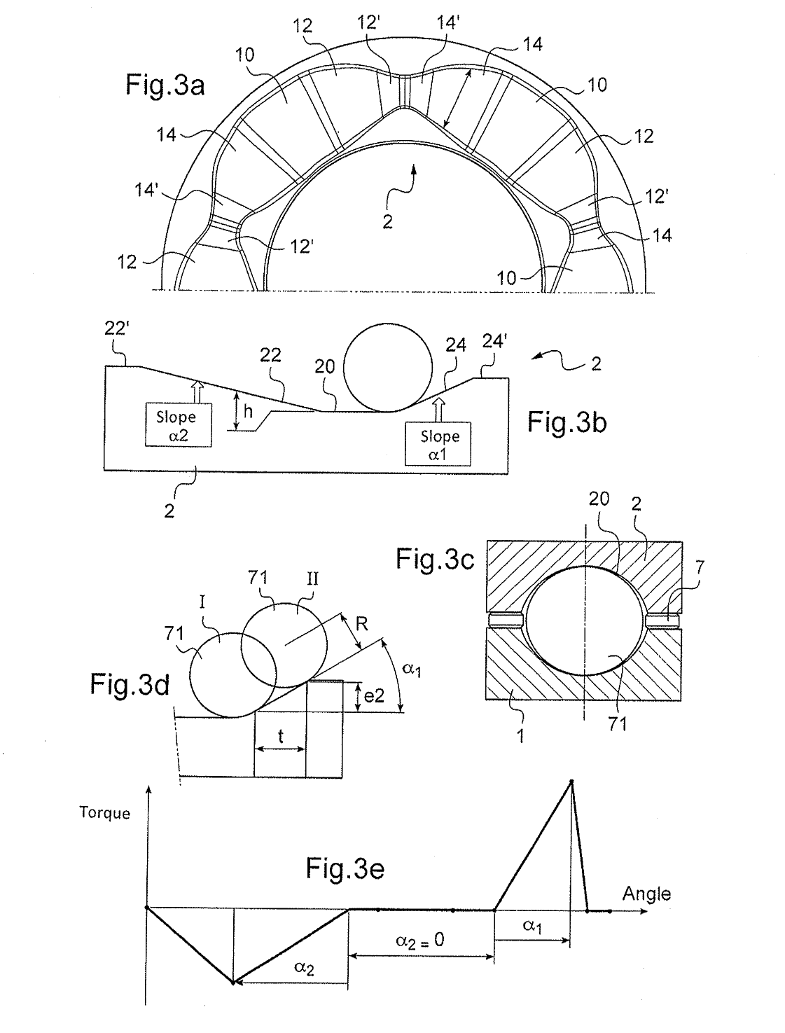

In FIG. 2c, which corresponds to the maximum compression of the resilient device 5, the ball has reached regions 12′, 22′ of the clutchplates that extend the inclined regions 12 and 22 (FIG. 3a).

Under such circumstances, no torque is transmitted.

The transmitted torque is the maximum torque when the ball is in contact simultaneously with the intersections of the regions 12 & 12′ and 22 & 22′.

FIG. 2d shows the travel of a ball (71) along a circular track of radius r in the central region 10.

FIG. 3a is a face view showing an example of the stationary clutchplate 2 (not having any fluting) with symmetrical ramps (the value of the angle α in this example is the same for both inclined regions on either side of the central region). The radial dimension dr of the regions 12 and 14 decreases going from the central region 10 towards the ends where they join the regions 12′ and 14′.

In FIG. 3b, the ramps are not symmetrical and they are made up of a plurality of circular sectors, each having a central region 20 (α=0) lying between two circular regions 22 (slope α2) and 24 (slope α1).

It should be observed that it is not essential for a non-inclined central region to be present. The ramp may comprise two regions 12, 14 (or 22, 24) that join each other. The rest point then corresponds to the join.

The inclined region 22 (slope α2) of the clutchplate co-operates with the region 12 (slope α2) of the clutchplate 1, and the inclined region 24 (slope α1) co-operates with the region 14 (slope α1) of the clutchplate 1.

FIG. 3c is a section view of the rounded shape of the ramp path that enables a circular sector to travel thereon. The radius of the track 20 is slightly greater than the radius of the ball 71.

FIG. 3e shows the variation in the torque transmitted between the clutchplates 1 and 2, and consequently between the rim 4 and the hub 3, as a function of the slope α1 or α2.

Operation is descried below.

### Operation

### 1) Taking-Up Torque Mode

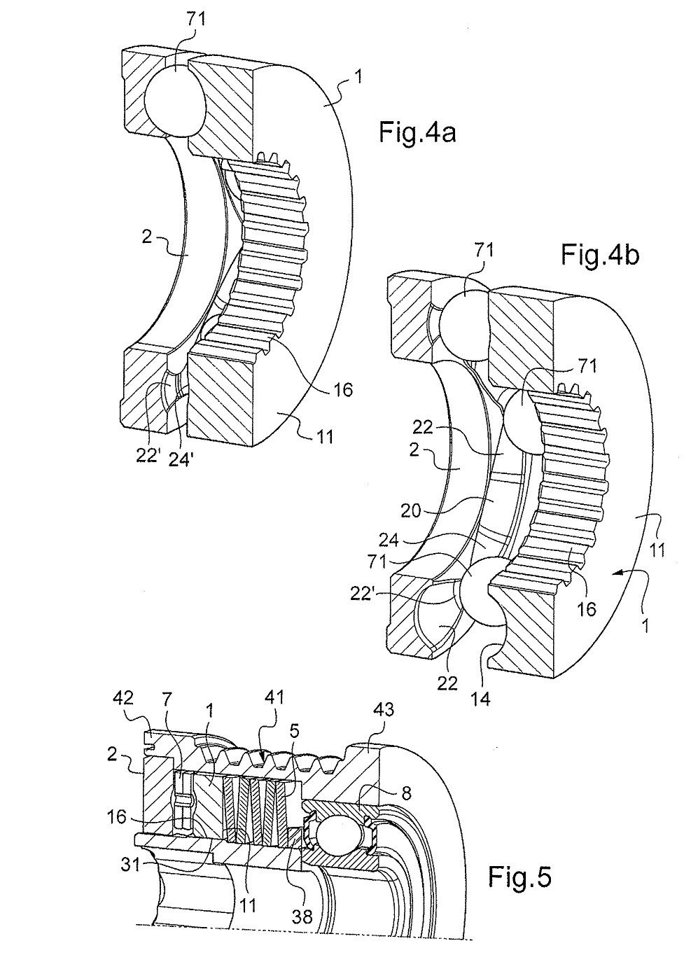

In the rest state (FIGS. 1a, 2a, 4a), the balls 71 rest on the bottom of the ramp, and the clutchplates are as close together as possible. The axial force is at a minimum (equal to the prestress if there is any). Under the effect of the increase in speed of the rim 4 and of the opposing torque from the alternator coupled to the hub 3, the clutchplate 1 moves axially relative to the stationary clutchplate 2 by virtue of the balls 71 moving onto the ramp of angle α1. As the ball moves up the ramp they cause the movable clutchplate 1 to move (FIGS. 2b, 3d, and 4b). This axial movement of the movable clutchplate 1 serves to compress the resilient device 5. Because of the stiffness Kax and the compression of the resilient device, there is an increase in the axial force (F spring: Fr). This force Fr is accompanied by a tangential force Ft where the ball 71 contacts the ramps 12 and 22 (FIGS. 2b and 4b). This tangential force Ft serves to generate a driving torque via the working radius r at which the balls are positioned (FIG. 2d). There, is a transfer of axial stiffness to angular stiffness.

### 2) Torque-Free Mode

During stages of deceleration, it is not always necessary to maintain torque. The inertia of the alternator suffices to keep it up to speed. It must not be braked.

In order to obtain a torque-free zone, use is made of a plane zone (FIG. 3d) of circumferential length that is adjustable for each configuration. The plane zone is situated at an axial level that corresponds to the rest state (minimum axial force given by the prestress, if any). Since the tangential component is zero when there is no slope, no torque is transmitted.

### 3) Deceleration Mode

It is necessary to terminate the end of the deceleration stage with stiffness to avoid an impact at the end of deceleration. The stiffness may be less than during the take-up stage. In order to obtain this smaller stiffness, the slope α2 is thus less steep (FIG. 3b). This shows the advantage of such a device that makes it possible to obtain different stiffnesses as a result of shape.

### 4) Torque-Limiter Function (Rupture)

It may be desirable to limit the maximum torque during certain stages. For example, during starting, the acceleration associated with inertia may generate very high levels of torque that are damaging for the transmission. It may be advantageous to limit these extreme torques that are of no use in normal mode.

To do this, the height of the slope α1 is limited (FIG. 2c). At this defined height, a straight clutchplate is positioned normal to the axis of rotation, thereby ensuring there is no longer any tangential component. The amount of torque that can be transmitted thus becomes zero (ignoring a small amount of friction). This shows that beyond this maximum height at maximum torque, there is a change to practically zero torque on the clutchplate.

### Literal Formulae For A Ramp of Slope α1: FIG. 3d

R is the radius of a ball 71;
t designates the movement of the ball 71 on the ramp of slope α1 for an elevation e2; and
e2 designates the height through which the clutchplate 1 is lifted

e2/t=tan α1

and

t=r×θ(rd)
The height of the lift is e2, i.e.

e2=r×θtan α1.
The force Fr of the lift is:

Fr2=Kax×e2,

i.e.

Kax×r×θ×tan α1
(in the absence of any initial prestress Fr in the rest state).

The tangential force is:

Ft2=Fr2×tan α1.
Ft2 can be deduced therefrom,

Ft2=Kax×r×θ×(tan α1)².
The torque in position II is

C=Ft2×r,

i.e.

C=Kax×r²×θ×(tan α1)²=Kax×θ×(r×tan α1)²
The angular stiffness Kang has the value C/θ, i.e.:

Kang=Kax×(r×tan α1)²
It can be seen that the angular stiffness is independent of the diameter R of the balls.

### DETAILED EXAMPLE

Five balls of 8 millimeter (mm) diameter placed at 72° intervals in their cage having a working radius r of 17.5 mm.

Four spring washers of outside diameter 45 mm, inside diameter 22 mm, and thickness 1.25 mm, made of steel giving axial stiffness of 400 newtons per millimeter (N/mm).
α1=24.85° (0.443 rd)
It is possible to calculate various numerical values:
(tan α1)²=0.214
R²=17.5²=306.2 square millimeters (mm²)
Whence (r×tan α1)²=65.68 mm² per radian (mm²/rd)
With Kax=440 N/mm
Giving Kang=440×65.68=28,900 Nmm per radian (Nmm/rd), i.e. 0.5 Nm/°.

The angular stiffness Kang is indeed that which is desired for filtering.

There are three available parameters (r, α1, Kax) for obtaining the desired filtering angular stiffness.

FIG. 5 shows a variant in the stack of Belleville spring washers 5 is mounted free in the bore 44 of the rim 4 and is in abutment against an annulus 38 secured to the hub (or against a collar of the hub 3). As in FIGS. 1a and 1b, the resilient device 5 is thus housed between the first clutchplate 1 constrained to rotate with the hub 3 and a part (endplate 6, annulus 38, or collar) also constrained to rotate with the hub 3, thereby ensuring that the resilient device 5 is subjected to axial compression only, excluding any twisting or friction.

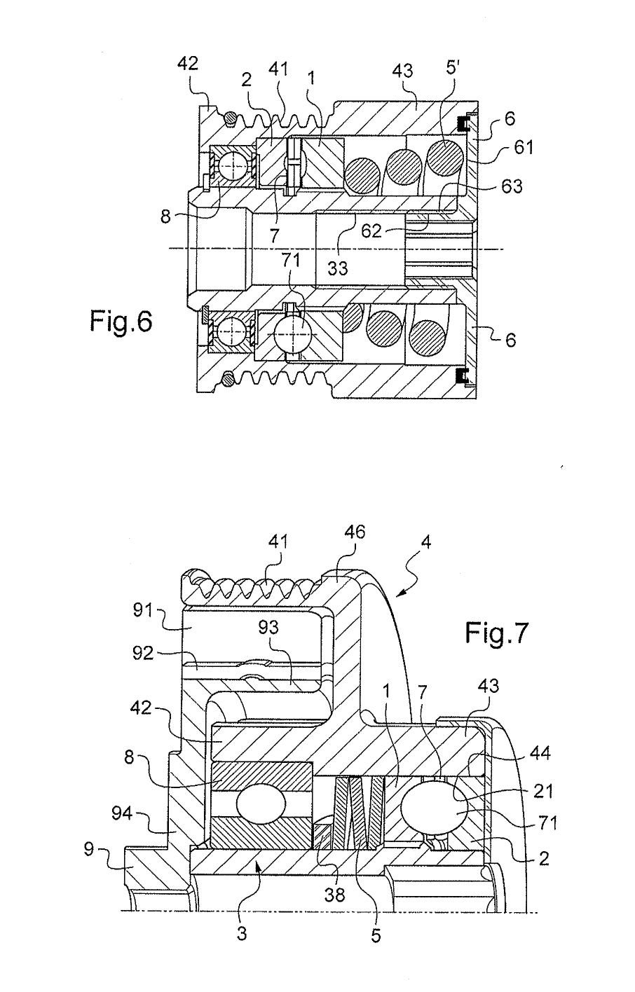

FIG. 6 shows a variant of FIGS. 1a and 1b in which the resilient device is a coil spring 5′.

FIG. 7 shows a crankshaft pulley in which a device of the invention is housed.

A high frequency torsional vibration damper TVD is housed in a cavity between the inner cylindrical region 42 and a cylindrical region 46 that presents an outer outline 41 that is grooved for receiving an automobile belt of type K. The function of the vibration damper is to absorb the high frequency torsional vibration specific to the crankshaft that generally lies in the range 200 hertz (Hz) to 400 Hz.

For this purpose, the damper comprises an elastomer ring 92 secured firstly to a cylindrical extension 93 of an endplate 94 of a part 9 that is constrained to rotate with the hub 3, and a flyweight 91 that is in the form of a ring.

As in FIG. 5, the resilient device 5 is arranged between the face 11 of the annular clutchplate 1 constrained to rotate with the hub and a part (or collar) 38 constrained to rotate with the hub 3.

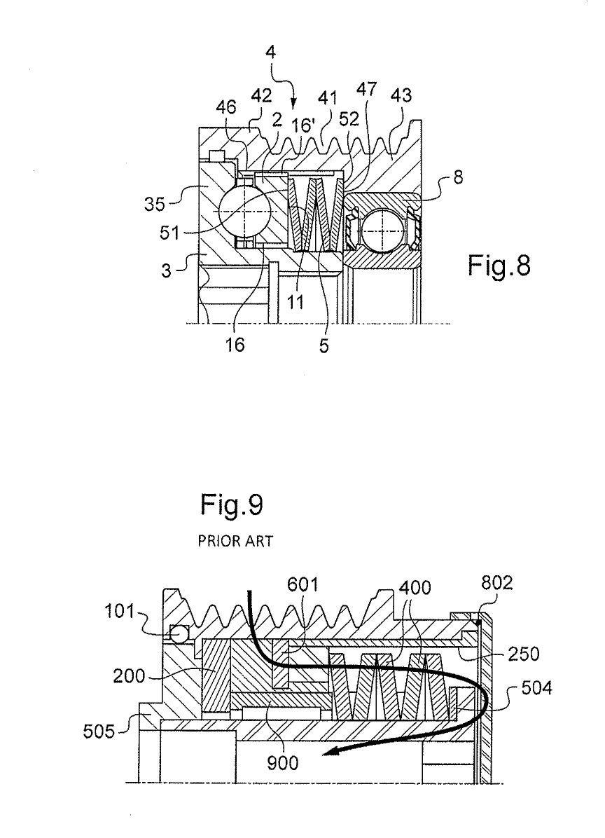

FIG. 8 shows a variant of FIG. 4 in which the resilient device is made up of two coil springs 5′ and 5″ in parallel.

There may be no need to have a torque-limiting function. When high levels of torque occur, e.g. on starting, e.g. in an application of the ADS type, it may be found necessary to obtain an opposing torque that goes beyond the maximum torque delivered by the resilient system. For this purpose, an abutment may be provided, e.g. on the rim, for limiting the axial movement of the movable clutchplate. This abutment may be fitted with devices for damping contact impacts.

In a linear ramp system (a constant) as described above, the stationary and movable clutchplates are not optimally synchronized because of possible slip between the balls and the ramps. The balls may be incapable of rolling without slip.

Synchronism between the clutchplates is defined by an equivalent angular offset, between the stationary clutchplate and the movable clutchplate, measured relative to the axis of the ball.

A preferred variant of the invention proposes a ramp shape that enables rolling to take place, while limiting or avoiding slip in order to provide improved synchronism.

It has been shown that a non-linear shape with a slope angle α that increases over the entire operating range provides a solution to this problem. A sinusoidal shape as mentioned in application U.S. 2009/194380 is not appropriate since it does not present a slope that increases over its entire deformation angle.

In the rest state (first point of the curve), the slope is preferably zero, thereby presenting the first state as described above (optionally under a small amount of spring prestress).

The slope increases progressively during rotation until it reaches a maximum value (second point of the curve). The maximum value of the angular movement β of the pulley is determined simultaneously both by the number of balls and by the maximum torque needed. For example, with six balls the maximum angle β is equal to 60°.

By way of example, if it is desired to have a maximum torque of 25 Nm at this maximum angle β of movement and with a maximum slope α, then it is possible to define the end point of the curve.

An intermediate point (in particular a mid-point) of the curve of increasing slope is advantageously selected as being the point corresponding to the maximum torque of the driven electrical equipment, e.g. 12 Nm for an alternator. It is arranged angularly in such a manner that the resultant angular stiffnesses delivered by the resilient device lies in the range 0.3 Nm/° to 0.9 Nm/° (for an alternator). This is the angular stiffness desired for providing the system with filtering.

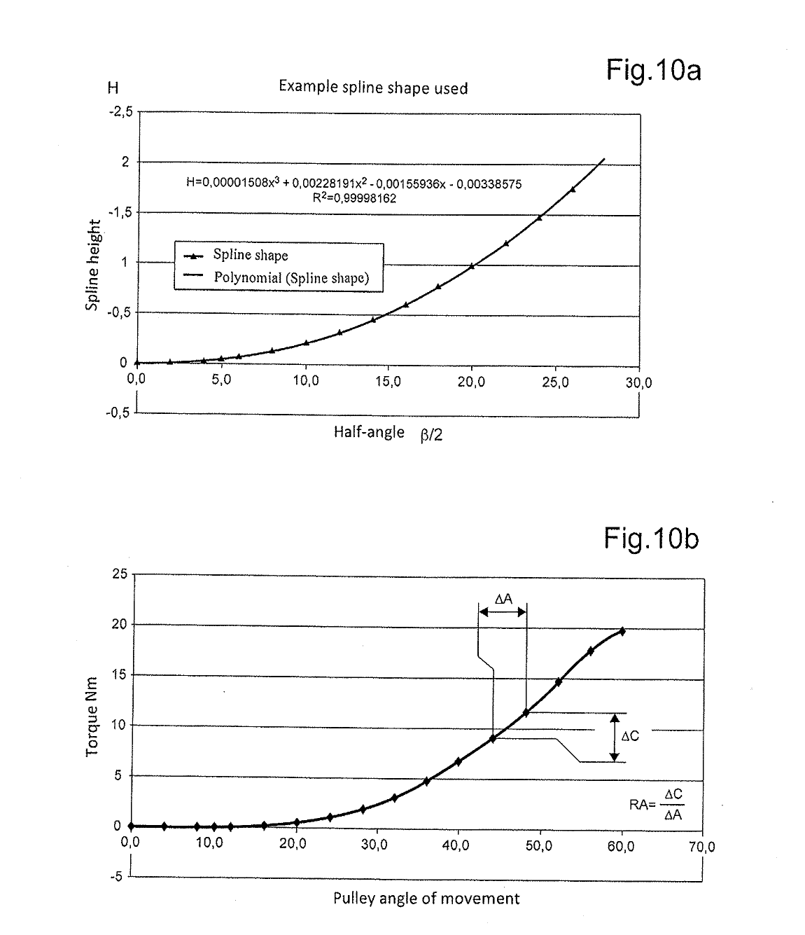

The curve of the ramp (height H of the current point as a function of the angle β of movement of the pulley) is of generally polynomial shape (see FIGS. 10a and 10b). These figures show only the positive portion of the curve followed by a ball for an angular movement of β/2; the other portion situated on the other side of the ball is symmetrical thereto. Since one of the annular clutchplates is constrained to rotate with the rim and the other with the hub, the movement angle β of the pulley is equal to twice that permitted by each of the clutchplates. For example, an angle β/2 of about 28° may be provided for six ramps that are identically distributed with a height H lying in the range 0 to 3 mm approximately, and more particularly in the range 0 to 2 mm.

The force may be calculated for all deformation points.

At a given point of the curve corresponding to a given value for the angular movement β, the torque and the angular stiffness RA increase with increasing axial stiffness of the resilient device (Belleville spring washers or spring). The angular stiffness Kang also depends on the value of the angle α at said point (as shown by the formulae given above in the description).

For example, consider a stack of four washers having an inside diameter of 22.4 mm and an outside diameter of 45 mm, with a thickness of 1.5 mm. By way of example, for a torque of 12 Nm, the height up the ramp is 1.48 mm (clutchplate movement through 2.96 mm), the force on the washers is 1340 newtons (N). This is obtained by conventional geometrical and force-resolving calculations.

The angular stiffness RA is obtained at the point under consideration by calculating the increase in torque relative to the increase in angle, i.e. RA=ΔC/ΔA. Specifically, in this example, the stiffness at this point is of the order of 0.7 Nm/°, as desired.

With this shape of curve, the stiffness increases in principle in a manner that is continuous as does the angular stiffness RA. A curve may be constructed, e.g. from these three characteristic points, preferably by using a polynomial (spline) function of second or third order.

The current points situated between the first point and the intermediate point correspond to torque being transmitted up to the maximum design value for the equipment under consideration (e.g. an alternator).

The current points between the intermediate point and the second point correspond to transferring torque above said maximum value, as occurs for example while idling because of the acyclism of the engine.

The torque curve (FIG. 10b) is shown for the complete pulley with the angle β thus being twice that of the ramp on its own (β/2).

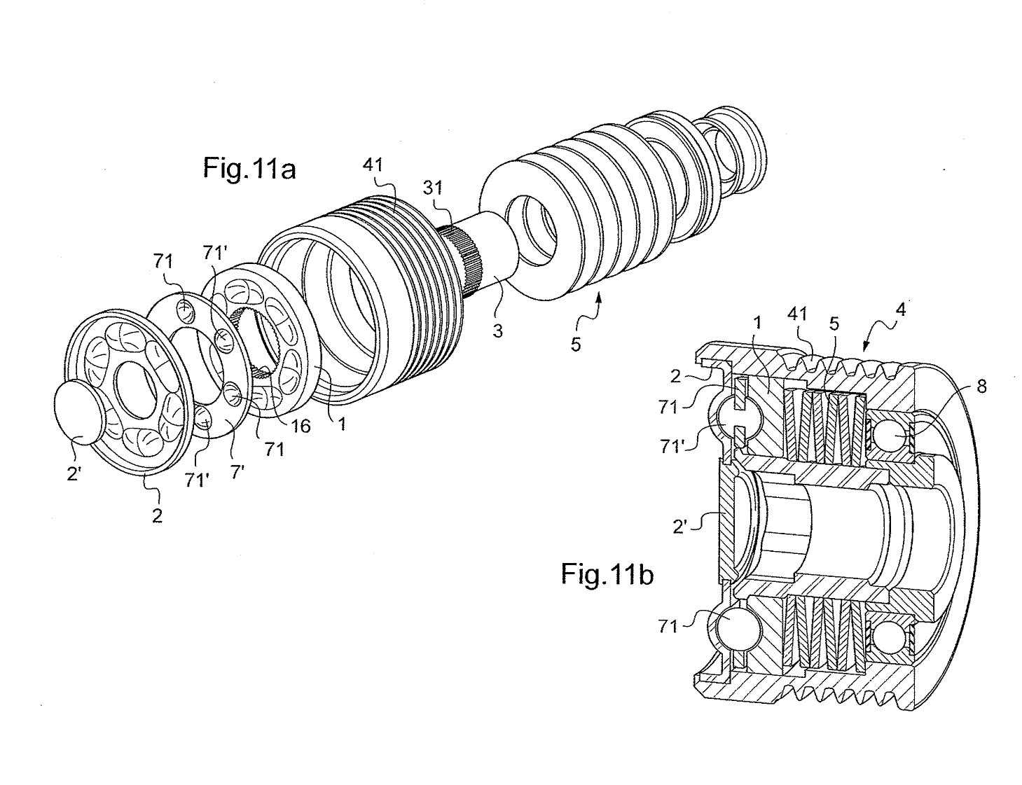

FIGS. 11a and 11b show an advantageous embodiment of the invention in which the balls 71 are arranged to be free to rotate in a ball cage 7′.

The ball cage 7′ also presents balls 71′ that are not movable in rotation, either because they are balls such as 71 that are held stationary in the ball cage 7′, or because they comprise shapes in relief 71′ having the same dimensions as the balls 71.

The balls 71 that are movable in rotation provide contact and torque transmission, while the balls 71 that are not movable in rotation or the shapes in relief (e.g. integrally molded with the ball cage) serve to provide contact with the ramps but without rolling, thereby ensuring that the cage is centered between the annular clutchplates 1, 2, 35, regardless of the elevation H of the clutchplate 1 that is axially movable. The balls 71 are housed in cylindrical holes of slightly greater diameter. The ball cage 7′ guarantees that the balls 71 are synchronous while remaining centered between the clutchplates by virtue of the shapes in relief 71′.

What is claimed is:

1. A decoupling pulley comprising two elements in rotation about a longitudinal axis, namely a rim and a hub, and also comprising a load support enabling relative rotation between the rim and the hub, together with a torque transmission element arranged between the rim and the hub, and including a resilient device that is deformable parallel to the longitudinal axis and including at least one resilient element, wherein the torque transmission element comprises:
a first annular clutchplate constrained to rotate with one of the two elements constituted by the rim and the hub, and axially movable relative thereto, having a first end face in contact with a first end face of the resilient device and a second end face, opposite from the first end face, and including at least a first ramp path having at least one inclined zone forming a circular sector centered on the longitudinal axis and forming a non-zero angle relative to a plane perpendicular to said longitudinal axis;
a second annular clutchplate constrained to rotate with the other one of the two elements comprising the hub and the rim, having an end face including at least one second ramp path having at least one inclined zone forming a circular sector centered on the longitudinal axis and making a non-zero angle relative to a plane perpendicular to said longitudinal axis; and
a holding cage including rolling elements such as balls, placed between the first and second annular clutchplates in such a manner that as a function of the relative angular position of the rim and the hub, the deformable resilient device is compressed axially by co-operation between at least one said rolling element and at least one said inclined zone of each of the first and second annular clutchplates, the axial compression force as generated in this way being accompanied by a tangential force that is a function of said angle and that transmits torque between the first and second annular clutchplates, and consequently between the rim and the hub.

2. A decoupling pulley according to claim 1, wherein said angle is constant.

3. A decoupling pulley according to claim 1, wherein a ramp path also includes at least one non-inclined zone.

4. A decoupling pulley according to claim 3, wherein the ramp path includes a non-inclined central zone arranged between first and second inclined zones forming respective non-zero angles α1 and α2 relative to a plane perpendicular to said longitudinal axis.

5. A decoupling pulley according to claim 4, wherein α1=α2.

6. A decoupling pulley according to claim 1, wherein a said rolling element is a ball.

7. A decoupling pulley according to claim 6, wherein the ramp path has a radial dimension that decreases going away from a central region towards two end regions.

8. A decoupling pulley according to claim 6, including a plurality of balls housed in a ball cage and movable in rotation therein.

9. A decoupling pulley according to claim 8, wherein the ball cage includes balls that are not movable in rotation and that have the same diameter as the balls that are movable in rotation, or that it includes shapes in relief having the same dimensions as the balls that are movable in rotation, to provide non-rolling contact with the ramp paths.

10. A decoupling pulley according to claim 1, wherein the resilient device is a stack of Belleville spring washers.

11. A decoupling pulley according to claim 1, wherein the resilient device comprises at least one coil spring.

12. A decoupling pulley according to claim 1, wherein the first annular clutchplate is constrained to rotate with the hub and wherein the second annular clutchplate is constrained to rotate with the rim.

13. A decoupling pulley according to claim 12, wherein, opposite from the first end face of the deformable resilient device, the hub includes an abutment element that is constrained to rotate together therewith in rotation and that presents a bearing face for a second end face of the deformable resilient device.

14. A decoupling pulley according to claim 13, wherein the abutment element is an annular shoulder of the hub or an annular bearing washer engaged around the hub.

15. A decoupling pulley according to claim 13, wherein the abutment element is an endplate of the hub.

16. A decoupling pulley according to claim 1, wherein said angle increases from a minimum value in a starting region of the ramp in which the deformable resilient device is not axially compressed up to a maximum value in an end region of the ramp in which the deformable resilient device presents maximum axial compression.

17. A decoupling pulley according to claim 16, wherein the minimum angular value in the start region of the ramp is equal to 0°.

18. A decoupling pulley according to claim 16, wherein the variation of said angle is defined by a polynomial curve of second or third order passing via a first point corresponding to the minimum value of the angle α in the starting region of the curve, and via a second point corresponding to the maximum value in the region of the end of the curve.

19. A decoupling pulley according to claim 18, wherein said polynomial curve also passes via an intermediate point corresponding to a nominal maximum torque for transmission between the rim and the hub, and to a predetermined angular stiffness.

20. A decoupling pulley according to claim 1, wherein the rim and/or the hub present(s) an abutment limiting the axial movement of the first and/or second annular clutchplate.
